(19) United States
(12) Patent Application Publication
(10) Pub. No.: US 2015/0150060 A1
(43) Pub. Date: May 28, 2015

(54) UNIFIED ACCESS METHOD AND DEVICE FOR DIGITAL TELEVISION BROADCASTING AND MOBILE DATA COMMUNICATION

(71) Applicant: HANGZHOU CLOUDCHAIN NETWORK TECHNOLOGY CO., LTD., ZHEJIANG (CN)

(72) Inventor: JIAN WU, ZHEJIANG (CN)

(73) Assignee: HANGZHOU CLOUDCHAIN NETWORK TECHNOLOGY CO., LTD., ZHEJIANG (CN)

(21) Appl. No.: 14/224,600

(22) Filed: Mar. 25, 2014

(30) Foreign Application Priority Data
Nov. 25, 2013 (CN) 201320705252.5

(51) Int. Cl. H04N 21/61; H04N 21/482

(52) U.S. Cl. CPC H04N 21/6131; H04N 21/6125; H04N 21/482
USPC 725/62

(57) ABSTRACT

A unified access method and a unified access device for digital television broadcasting and mobile data communication, wherein a 3G mobile data communication module and a digital television broadcasting signal receiver are used for receiving/sending communication data and receiving digital television broadcasting signals respectively, and an application processor is used for converting the communication data and the digital television broadcasting transfer stream into IP data packet capable of being transmitted through a WLAN or an Ethernet; any client equipment is connected to the WLAN or the Ethernet port of the application processor, so that the client equipment is able to obtain the mobile Internet applications with digital television broadcasting and data communication services. Also disclosed are functions for the smart mobile terminals to play digital television broadcasting programs except visit Internet applications via 3G mobile data communication network or the other next generation mobile data communication network by IP protocol.

### CROSS-REFERENCE TO RELATED APPLICATIONS

This application claims priority to Chinese Application No. 201320705252.5, having a filing date of Nov. 25, 2013, the entire contents of which are hereby incorporated by reference.

### FIELD OF TECHNOLOGY

The present disclosure relates to a multi-channel unified access method, and in particular to a unified access method and a unified access device for digital television broadcasting and mobile data communication.

### BACKGROUND

At present, the unity of digital televisions and data communication is an irresistible trend in services and technologies. Since year 2000 the broadband networks based on IP protocol rose, people who subscribe the broadband Internet services had been watching video contents such as movies and teleplays on their personal computers by the Internet protocol television IPTV techniques. With the opening of the 3^{rd}/4^{th} generation mobile communication which provide not only the mobile telecommunication services but also the mobile data communication services, there are an arrival of a mobile Internet era in which the smart mobile phone and terminals can play mobile video programs in anywhere and anytime, thus the network video based on Internet protocol television IPTV is about to be moved to the state of art a mobile network video. At the same time, a television broadcasting technologies for cable, terrestrial and satellite systems are also subjected to a digitalization evolution quickly, however, we find that various different digital television broadcasting systems and standards such as DTMB/CMMB in China, DVB in Europe, ASTC in American, ISDB in Japan and so on are generated in different countries and organizations, and these standards are non-uniform and incompatible in technologies, and the digital television broadcasting transmission protocol completely differs from IP protocol communication standards. As a matter of fact almost everything related to communications is based upon IP protocol which is an essential data transmission standard at this time, it is a big problem how to unify the digital television broadcasting and data communication in IP protocol network.

### SUMMARY

The present disclosure aims at creating a unified access method and a unified access device for digital television broadcasting and mobile data communication in IP protocol network. In the present disclosure, unified access capable of meeting the needs of mobile Internet applications is provided for the digital television broadcasting network and the 3G mobile data communication network with different standards to each other, so as to provide the smart mobile terminals or mobile phones with Wi-Fi and Ethernet access gateways for digital television broadcasting and 3G mobile data communication network, and thus, there are the new functions for the smart mobile terminals or mobile phone to play digital television programs except visit Internet applications via 3G mobile data communication network by IP protocol.

Non-uniform of digital television broadcasting standards and mobile data communication standards in technologies is an established fact and cannot be changed in quite a long time. In order to bypass the technical problem aforementioned and to unify the mobile Internet services in both digital television broadcasting and mobile data communication, the technical solution provided by the present disclosure is as follows: a unified access method for digital television broadcasting and mobile data communication, characterized in that: a mobile data communication module receives/sends communication data with 3G mobile communication cell-base station and sends/receives the communication data with an application processor, and a digital television broadcasting signal receiver receives the digital television transfer stream from the digital television broadcasting transmission station and sends the received digital television transfer steam to an application processor, respectively, the application processor converts the communication data and digital television transfer stream into IP data packet capable of being transmitted through a WLAN or an Ethernet; and client equipment is accessed to the WLAN or the Ethernet of the application processor, so that the client equipment is connected to visiting the mobile Internet applications and playing the digital television programs by IP protocol.

In the unified access method for digital television broadcasting and mobile data communication aforementioned, the digital television broadcasting signal receiver is a DTMB standard receiver, a CMMB standard receiver or a multi-standard receiver which is available for DTMB, DVB-T, ATSC, ISDB-T etc.

In the unified access method for digital television broadcasting and mobile data communication aforementioned, the specific method for converting the mobile Internet application data and digital television transfer stream into the IP data packet capable of being transmitted through the WLAN or the Ethernet by using the application processor includes:
the application processor packages the TS format data of the digital television broadcasting transfer stream into an IP data packet according to the Pid of the TS format data of the digital television broadcasting transfer stream received by the digital television broadcasting signal receiver; and
the application processor splices several packaged IP data packets into a video unit file capable of being independently played every several seconds or several hours, and stores the video unit file into a data buffer of a unified access gateway.

In the unified access method for digital television broadcasting and mobile data communication aforementioned, the specific method for watching and selecting a digital television broadcasting program by the client equipment includes:
the application processor makes the client equipment access the gateway with a WLAN in mode of a 802.11b/g/n protocol or an Ethernet port;
the client equipment applies the application processor for digital television EPG menu information;
the client equipment sends an Http request to the application processor according to the address in the digital television EPG menu information returned by the application processor;
the application processor responds the Http request of the client equipment and returns the corresponding video unit file and an index file thereof;
after receiving the video unit file and the index file thereof, the client equipment starts playing the video unit file guided by the index file and the index file will be refreshed as the next video unit file is generated; and
after the video unit file is played to the end, the client equipment plays the next video unit file according to the refreshed index file returned by the application processor.

The process for the client equipment to connect to the mobile Internet is as follows: after a 3G mobile network module being loaded in the application processor, a dialing program starts and establishes a point-to-point connection between the 3G mobile network module and a mobile communication cell-base station. The client equipment sends standard Ethernet data packet, which is request data of visiting mobile Internet applications, to the WLAN or Ethernet port of the application processor, and the application processor packages the Ethernet data in a point-to-point protocol PPP manner and then forwards to the uplink of the 3G mobile network module. The application processor receives the mobile Internet application data with PPP package from the downlink of 3G mobile network module and removes the data packet from PPP package into a standard Ethernet data packet, and searches routing table itself and forwards the standard Ethernet data packet to the client equipment for visiting mobile Internet applications.

A unified access device for digital television broadcasting and mobile data communication, which is used for realizing the method aforementioned, characterized by: including an application processor, wherein a 3G mobile communication network module and a digital television broadcasting signal receiver are connected to the application processor, and Wi-Fi modules and an Ethernet RJ45 port are further connected to the application processor; and an EPROM and an SDRAM are equipped on the application processor.

In the unified access device for digital television broadcasting and mobile data communication aforementioned, the digital television broadcasting signal receiver is a DTMB standard receiver.

In the unified access device for digital television broadcasting and mobile data communication aforementioned, the digital television broadcasting signal receiver is a CMMB standard receiver.

In the unified access device for digital television broadcasting and mobile data communication aforementioned, the digital television broadcasting signal receiver is a multi-standard receiver which is available for DTMB, DVB-T, ATSC, ISDB-T etc.

English nouns and abbreviations in the contents aforementioned are the specific concepts with definite meanings in the art, and illustrated below for making the description to be clearer:
Pid: Packet Identifier.
IP package: IP protocol data package.
TS: Transfer Stream.
EPG: Electronic Program Guide.
Http protocol: hyper text transfer protocol.
Wi-Fi: Wireless Fidelity.
WLAN: Wireless Local Area Networks.
EPROM: an ROM (read only memory) with an erasable function and capable of reprogramming immediately after erasing, the stored contents needing to be erased at first in a mode of irradiating a transparent window on the IC (integrated circuit) card thereof by ultraviolet ray before writing.
CMMB: China Mobile Media Broadcasting
DTMB: Digital Territorial Media Broadcasting
DVB-T: Digital Video Broadcasting for Territorial
ATSC: Advanced Television Systems Committee
ISDB-T: Integrated Services Digital Broadcasting for Territorial

Compared with the past, in the present disclosure, unified access capable of meeting the needs of mobile Internet applications is provided for the digital television broadcasting network and the 3G mobile data communication network with different standards to each other, so as to provide Wi-Fi and Ethernet access gateways for digital television broadcasting and mobile data communication for the smart mobile terminals such as smart mobile phones and smart Pad, and thus, there are the new functions for the smart mobile terminals to play digital television broadcasting programs expect to visit Internet applications via mobile Internet. According to the present disclosure, unified access in mobile Internet services are achieved as an IP protocol standard access for digital television broadcasting network and mobile data communication network without unifying the technology standards of the existing networks; and the unified access method and the unified access device are good in maturity, economical efficiency and operability.

### BRIEF DESCRIPTION

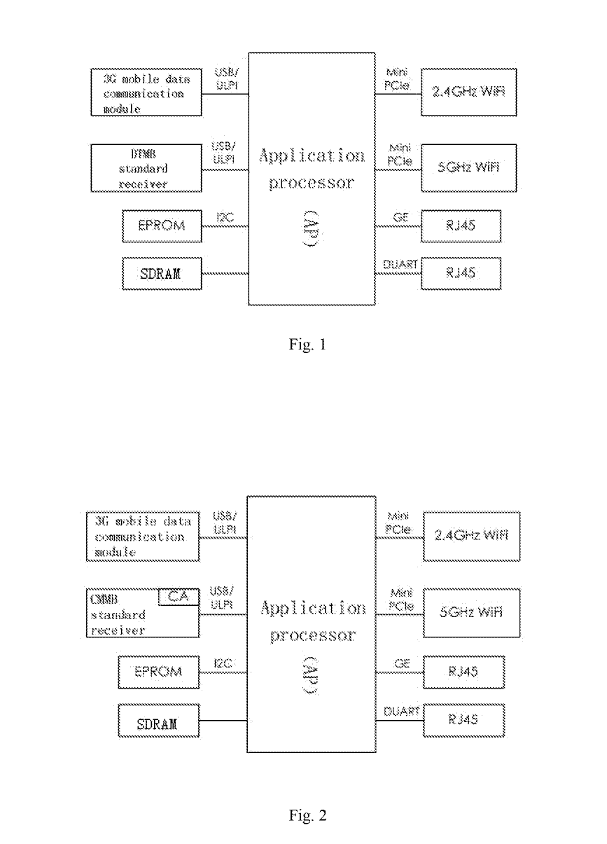

FIG. 1 shows a structural schematic drawing of embodiment 1 of the present invention;

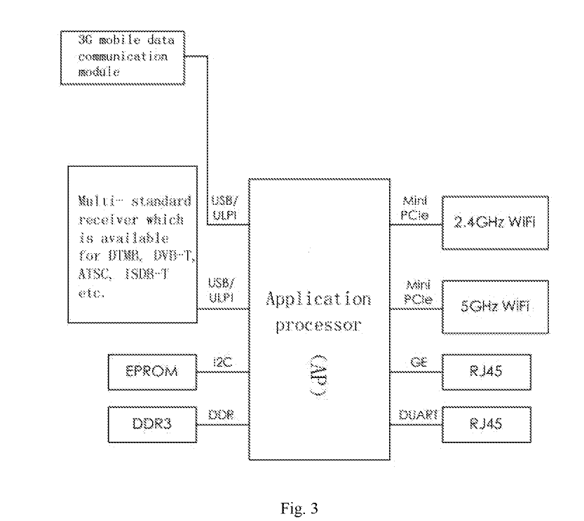

FIG. 2 shows a structural schematic drawing of embodiment 2 of the present invention;

FIG. 3 shows a structural schematic drawing of embodiment 3 of the present invention.

### DETAILED DESCRIPTION

The present invention is illustrated in detail below in conjunction with the accompanying drawings and embodiments. However, the illustration is not the basis for limiting the present invention.

### Embodiment 1

A unified access method for digital television broadcasting and mobile data communication is disclosed. It includes a mobile data communication module receives/sends communication data with 3G mobile communication cell-base station and sends/receives the communication data with an application processor, and a digital television broadcasting signal receiver receives the digital television transfer stream from the digital television broadcasting transmission station and sends the received digital television transfer steam to an application processor, respectively, the application processor converts the communication data and digital television transfer stream into IP data packet capable of being transmitted through a WLAN or an Ethernet; and client equipment is accessed to the WLAN or the Ethernet of the application processor, so that the client equipment is connected to visiting the mobile Internet applications and playing the digital television programs by IP protocol.

The digital television broadcasting signal receiver is a DTMB standard receiver, a CMMB standard receiver or a multi-standard receiver which is available for DTMB, DVB-T, ATSC, ISDB-T etc.

It should be noted that the mobile data communication module may be a 3G communication network card or the other next generation mobile communication signal receiver, which is not limited in the embodiment of the present invention.

In the unified access method for digital television broadcasting and mobile data communication aforementioned, the specific method for converting the mobile Internet application data and digital television transfer stream into the IP data packet capable of being transmitted through the WLAN or the Ethernet by using the application processor is disclosed. It includes:
the application processor packages the TS format data of the digital television broadcasting transfer stream into an IP data packet according to the Pid of the TS format data of the digital television broadcasting transfer stream received by the digital television broadcasting signal receiver; and
the application processor splices several packaged IP data packets into a video unit file capable of being independently played every several seconds or several hours, and stores the video unit file into a data buffer of a unified access gateway.

The specific method for watching and selecting a digital television broadcasting program by the client equipment includes:

the application processor makes the client equipment access the gateway with a WLAN in mode of a 802.11b/g/n protocol or an Ethernet port;

the client equipment applies the application processor for digital television EPG menu information;

the client equipment sends an Http request to the application processor according to the address in the digital television EPG menu information returned by the application processor;

the application processor responds the Http request of the client equipment and returns the corresponding video unit file and an index file thereof;

after receiving the video unit file and the index file thereof, the client equipment starts playing the video unit file guided by the index file and the index file will be refreshed as the next video unit file is generated; and

after the video unit file is played to the end, the client equipment plays the next video unit file according to the refreshed index file returned by the application processor.

### Embodiment 2

The digital terrestrial multimedia broadcast DTMB standards of China were published in the year 2008 it is a new beginning for the digital television broadcasting for terrestrial. It is announced that from year 2014 all the digital televisions produced in China had to be available for receiving DTMB signals for people to watch DTV and HDV program at home, and at that time the DTMB television broadcasting signals have been coverage in the most of domestic cities and towns already. Under the era background of comprehensive development of mobile Internet and terrestrial digital televisions, in embodiment 2 of the present invention, unified access capable of meeting the needs of mobile Internet is provided for the mobile Internet and a terrestrial digital television network with different standards to each other, so as to provide Wi-Fi gateways as an access hot-spot for digital television broadcasting and mobile data communication for the smart mobile terminals and mobile phones, and thus, there are new functions for mobile phones and Pads to watch the DTMB programs from terrestrial television broadcasting stations by Wi-Fi.

As shown in FIG. 1, a unified access device for digital television broadcasting and mobile data communication, which is used for realizing the method aforementioned, includes: an application processor, wherein a 3G communication network module and a DTMB standard receiver are connected to the application processor, and Wi-Fi modules (2.4 GHz Wi-Fi and 5 GHz Wi-Fi) and an Ethernet RJ45 port are also connected to the application processor, and an EPROM and a DDR3 SDRAM are equipped on the application processor.

The Wi-Fi module of the application processor of the present disclosure adopts a WLAN access mode of 802.11b/g/n (or through an Ethernet port), any client equipment supporting WALN access mode can be connected to the application processor. The unified wireless gateway designed by the present disclosure uplinks the mobile Internet as a WAN provided by 3G network module with CDMA, WCDMA and TD-SCDMA mobile communication standards or by 4G communication modules in the future, so as to provide an Internet access service for any client equipment supporting WLAN access mode; modules supporting the DTMB standards of the present disclosure provide a function of receiving terrestrial digital television signals, and can provide a service for synchronously watching digital television broadcasting programs for any client equipment supporting WLAN access mode; and in the present disclosure, a 3G mobile data communication network and a DTMB terrestrial digital television network are converged to be converted into a Wi-Fi wireless access standard interface and an Ethernet interface, so that unified access in mobile Internet services are achieved as an IP protocol standard access for a DTMB network and 3G mobile data communication network without unifying the technology standards of the existing networks, which is good in maturity, economical efficiency and operability. The device provided by the present disclosure further have the additional functions such as access authentication, opening service, network security, firewall, routing management, access control and so on, which are able to provide the safety of the access gateway and protect management authority in services , and build a data encryption transmission tunnel for data transmission.

### Embodiment 3

China mobile multimedia broadcasting CMMB standards were published in the year 2006, which is suitable for broadcasting systems used for wirelessly transmitting multimedia signals such as television broadcasting, voice broadcasting and data transmission by virtue of the satellites and/or the ground transmitting station, and for watching multimedia broadcasting programs by portable hand-held terminals with small screens of no more than 7 inches sizes. Since the beginning of CMMB program broadcasting in the Olympic Games 2008, the CMMB program signals have already cover the most of cities and towns by the end of the year 2012, CMMB services have been the top leading position in the industry of wireless digital television broadcasting of China, however, the further development of the service of CMMB is greatly influenced due to without Internet applications and services in the age of Internet. With the arrival of the irresistible trend of the merge of television broadcasting and data communication in services, CMMB services is necessarily to be combined with mobile Internet to obtain a stability development basis. According to the present disclosure, a unified designed is performed on access for networks with CMMB standards and 3G communication standards, network hotspot Wi-Fi access gateways for CMMB multimedia broadcasting and mobile broadband are provided for the smart mobile terminals and mobile phones in combination with the needs of mobile Internet applications, and thus, there are new functions for mobile phones and Pads to watch all of CMMB digital television broadcasting programs by Wi-Fi access mode. Therefore, embodiment 3 of the present disclosure is a device used for providing unified access capable of meeting the needs of mobile Internet applications for the CMMB mobile multimedia broadcasting network and the 3G mobile data communication network with different standards to each other.

The structure of the device is as shown in FIG. 2, and the device includes an application processor, wherein a 3G mobile communication network module and a digital television broadcasting signal receiver are connected to the application processor, and Wi-Fi modules and an Ethernet RJ45 port are further connected to the application processor; and an EPROM and an SDRAM are equipped on the application processor.

The device provided by the present disclosure adopts a WALN broadband access mode of 802.11b/g/n protocol (or through an Ethernet port), any client equipment supporting WALN access mode can be connected; the unified wireless gateway designed by the present disclosure uplinks the mobile Internet as a WAN provided by 3G network module with CDMA, WCDMA and TD-SCDMA mobile communication standards or by 4G communication modules in the future, so as to provide an Internet access service for any client equipment supporting WLAN access mode; the modules supporting the DTMB standards of the present disclosure provide a function of receiving CMMB mobile multimedia broadcasting signals, and the application processor synthesized an audio and video stream from CMMB module into a transfer stream TS format data stream, so as to provide a service for synchronously watching CMMB mobile multimedia broadcasting programs with and/or without conditional access CA authority for any client equipment supporting WLAN access mode. According to the present disclosure, a 3G mobile data communication network and a CMMB mobile multimedia broadcasting network are accessed by any client equipment with a Wi-Fi wireless access mode or an Ethernet RJ45 port finally, so that unified access in mobile Internet services are achieved for the different access standards and application services of CMMB mobile multimedia broadcasting network and 3G mobile data communication network, without changing the standards of the existing networks. The present disclosure is good in maturity, economical efficiency and operability.

### Embodiment 4

Because different terrestrial/mobile digital television broadcasting standards are adopted in global countries and regions, and there are several standards such as CMMB, DVB-T, DVB-H, DVB-S, ISDB-T, T-DMB and ATSC M/H without compatibility each other, therefore, the compatibility of the standard specifications of digital mobile television broadcasting with different systems have been solved, some digital television broadcasting receiver IC chips for multi-system are developed to support for digital television terminals to receive different mobile television broadcasting systems effectively. Under the background of the general trend of the uniform of digital television broadcasting and data communication in mobile Internet services, the present disclosure is a design supporting unified access for a global mobile television broadcasting network and a 3G mobile data communication standard network, the Wi-Fi gateways as the access network hotspot for multi-system television broadcasting and mobile broadband are provided for the smart mobile terminals and mobile phones in combination of the needs of mobile Internet applications and services, and thus, there are new functions for mobile phones and Pads to watch the local digital television broadcasting programs by configuring the Wi-Fi gateways matched with the corresponding digital television standard according to different countries and regions.

As shown in FIG. 3, a unified access device for digital television broadcasting and mobile data communication, includes: an application processor, wherein a 3G data communication network module and a multi-system digital television broadcasting signal receiver which is available for DVB-T, ISDB-T, T-DMB, ATSC, CMMB, CTTB and so on are connected to the application processor, and Wi-Fi modules (2.4 GHz Wi-Fi and 5 GHz Wi-Fi) and an Ethernet RJ45 port are further connected to the application processor; and an EPROM and a SDRAM are equipped on the application processor.

The device designed by the present disclosure adopts a WALN broadband access mode of 802.11b/g/n protocol or through an Ethernet port, any client equipment supporting WALN access mode can be connected; the device designed by the present disclosure uplinks the mobile Internet as a WAN provided by 3G network module with CDMA, WCDMA and TD-SCDMA mobile communication standards or by the other next generation mobile communication modules in the future, so as to provide an Internet access service for any client equipment supporting WLAN access mode. The design supporting the multi-system digital television broadcasting standard of the present disclosure provide a function of receiving local digital television broadcasting signals with different digital mobile television broadcasting standards of countries and regions, so as to provide a service for watching local mobile digital television broadcasting programs with different standards for any client equipment supporting WLAN access mode. According to the present disclosure, a 3G mobile data communication network and mobile digital television broadcasting network with various standards are accessed by any client equipment with a Wi-Fi wireless access mode or an Ethernet RJ45 port finally, so that unified access in mobile Internet services are achieved for the different access standards and application services of multi-system digital television broadcasting network and 3G mobile data communication network, without changing the standards of the existing networks. The present disclosure is good in maturity, economical efficiency and operability, further have the additional functions such as access authentication, opening service, network security, firewall, routing management, access control and so on, which are able to provide the safety of the access gateway and protect management authority in services, and build a data encryption transmission tunnel for data transmission.

The meanings of some signs in the accompanying drawings are as follows:
USB: the abbreviation of universal serial bus.
ULPI: UTMI+low-pin interface used for a high-speed USB and a USB On-the-Go (OTG) transceiver chip.
MINI PCIE: MINI PCI-E, which is an interface based on a PCI-E bus.
GE: Gigabit Ethernet.
UART: Universal Asynchronous Receiver Transmitter.
SDRAM: Synchronous Dynamic Random Access Memory.

While this invention has been described in detail with reference to certain exemplary embodiments, it should be appreciated that the present invention is not limited to those precise embodiments. Rather, in view of the present disclosure which describes the current best mode for practicing the invention, many modifications and variations would present themselves, to those of skilled in the art without departing from the scope and spirit of this invention. The scope of the invention is, therefore, indicated by the following claims rather than by the foregoing description. All changes, modifications, and variations coming within the meaning and range of equivalency of the claims are to be considered within their scope.

What is claimed is:

1. A unified access method for digital television broadcasting and mobile data communication, including:
providing a mobile data communication module which receives/sends communication data with 3G mobile communication cell-base station and sends/receives the communication data with an application processor;
providing a digital television broadcasting signal receiver receives the digital television transfer stream from the digital television broadcasting transmission station and sends the received digital television transfer steam to an application processor, respectively; converting with the application processor, the communication data and digital television transfer stream into IP data packet capable of being transmitted through a WLAN or an Ethernet; and
accessing client equipment to the WLAN or the Ethernet of the application processor, so that the client equipment is connected to visiting the mobile Internet applications and playing the digital television programs by IP protocol.

2. The unified access method for digital television broadcasting and mobile data communication of claim 1, wherein the digital television broadcasting signal receiver is a multi-standards supporting digital television broadcasting signal receiver, including a DTMB receiver and/or a CMMB receiver or the other digital television broadcasting standard receiver.

3. The unified access method for digital television broadcasting and mobile data communication of claim 1, wherein the transfer stream of the digital television broadcasting signals includes a packet identifier and the specific method for converting the mobile Internet application data and digital television transfer stream into the IP data packet capable of being transmitted through the WLAN or the Ethernet by using the application processor includes:
the application processor packages the TS format data of the digital television broadcasting transfer stream into an IP data packet according to the Pid of the TS format data of the digital television broadcasting transfer stream received by the digital television broadcasting signal receiver; and
the application processor splices several packaged IP data packets into a video unit file capable of being independently played every several seconds or several hours, and stores the video unit file into a data buffer of a unified access gateway.

4. The unified access method for digital television broadcasting and mobile data communication of claim 1, wherein the method further includes:
the specific method for watching and selecting a digital television broadcasting program by the client equipment includes:
the application processor makes the client equipment access the gateway with a WLAN in mode of a 802.11b/g/n protocol or an Ethernet port;
the client equipment applies the application processor for digital television EPG menu information;
the client equipment sends an Http request to the application processor according to the address in the digital television EPG menu information returned by the application processor;
the application processor responds the Http request of the client equipment and returns the corresponding video unit file and an index file thereof;
after receiving the video unit file and the index file thereof, the client equipment starts playing the video unit file guided by the index file and the index file will be refreshed as the next video unit file is generated; and
after the video unit file is played to the end, the client equipment plays the next video unit file according to the refreshed index file returned by the application processor.

5. A unified access device used for digital television broadcasting and mobile data communication, including: an application processor, a mobile data communication module, a digital television broadcasting signal receiver, a Wi-Fi module, an Ethernet RJ45 port, an EPROM and an SDRAM, wherein the application processor is connected with the mobile data communication signal module and the digital television broadcasting signal receiver, and is further connected with the Wi-Fi module and the Ethernet RJ45 port; and the application processor is further configured with the EPROM and the SDRAM.

6. The unified access device of claim 5, wherein the digital television broadcasting signal receiver is a DTMB standard receiver.

7. The unified access device of claim 6, wherein the digital television broadcasting signal receiver is a CMMB standard receiver.

8. The unified access device of claim 5, wherein the digital television broadcasting signal receiver is a multi-standard receiver which is available for DVB-T, ISDB-T, ATSC and so on.
